(19) United States
(12) Patent Application Publication
(10) Pub. No.: US 2008/0227574 A1
(43) Pub. Date: Sep. 18, 2008

(54) Hub for power transmission device and manufacturing method therefor

(75) Inventors: Michiyasu Nosaka, Anjo-city (JP); Haruhisa Shibata, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/076,022

(22) Filed: Mar. 13, 2008

(30) Foreign Application Priority Data
Mar. 16, 2007 (JP) 2007-68986
Mar. 19, 2007 (JP) 2007-71400

(51) Int. Cl. F16H 55/49; B29C 65/42

(52) U.S. Cl. 474/170; 264/262

(57) ABSTRACT

A hub 57 for a power transmission device consists of: an inner hub 59 consisting of a rigid body; a cylindrical section 61 consisting of an elastic body that is formed annularly around an outer circumference of the inner hub 59; an outer ring 63 consisting of a rigid body that is fixed on an outer circumference of the cylindrical section 61 and protrudes in an axially rearward direction; and a hub-side engagement section 65 consisting of an elastic body that is formed on an axially rearward circumferential surface of the outer ring 63 and that is engaged with a pulley side engagement section, wherein connection sections 81 consisting of elastic bodies that connect between a front end of the outer ring 63 and said hub-side engagement section 65 are formed at a front side of an outer circumference of the outer ring 63 where the hub-side engagement section 65 is not formed. Further, communication holes 281 that extend from the cylindrical section 61 to the hub-side concavo-convex section 65 are formed in the outer ring 263, and communication sections 283 consisting of elastic bodies that extend from the cylindrical section 61 to the hub-side concavo-convex section 65 are formed through the communication holes 281. Therefore, there is provided a hub for a power transmission device and its manufacturing method, wherein a sufficient pressure of the elastic material can fill the hub-side concavo-convex section at the time of insert molding so as to afford sufficient strength to the hub-side concavo-convex section.

### BACKGROUND OF THE INVENTION

1. Field of the Invention

The present invention relates to a hub for a power transmission device that has a shock absorbing function for attenuating vibration, shock, etc., at the time of power transmission, and a manufacturing method for such hub for the power transmission device.

2. Description of the Related Art

Generally, a compressor for an automobile air conditioner receives power that is transmitted from an external power source such as an engine and the like via a belt, pulley and the like. In some power transmission devices used for such power transmission, a concavo-convex section is formed on an inner circumference of a pulley and another concavo-convex section consisting of an elastic material is formed on an outer circumference of a hub at a driven side, so that both of the concavo-convex sections are engaged with each other. The hub in such a power transmission device consists of: a metallic inner hub that abuts against a shaft of a compressor; a cylindrical section consisting of an elastic body that is formed on an outer circumference of the inner hub; a metallic outer ring that is provided on an outer circumference of the cylindrical section; and a hub-side engagement section that is provided on an outer circumference of the outer ring and engaged with the concavo-convex section provided on the inner circumference of the pulley. Then, the cylindrical section and the hub-side engagement section both consisting of elastic bodies attenuate vibration and shock, etc.

This hub for the power transmission device is manufactured by insert molding, wherein the metallic inner hub and the outer ring are loaded in a die. FIG. 22 is a cross-sectional view showing the insert molding using the die. A stationary die 11 and a movable die 13 that are axially separated from each other form therebetween a cavity for molding the hub and the inner hub 15 and the outer ring 17 are disposed as inserts in the cavity. In this state, a cavity 19 for molding the cylindrical section is formed between the inner hub 15 and the outer ring 17, and a cavity 21 for molding the hub-side engagement section is formed around the outer circumference of the outer ring 17. Further, an injection gate 23 is formed in the stationary die 11 at a front side of the outer ring 17.

In this die, as indicated by arrow 25, an elastic material supplied through the injection gate 23 first fills the cavity 19 for molding the cylindrical section. Then, as indicated by arrow 27, the elastic material flows beneath the outer ring 17 and passes through a gap between a rear end 17a of the outer ring 17 and the movable die 13 to fill the cavity 21 for molding the hub-side engagement section.

A space beneath the outer ring 17 and the gap between the rear end 17a of the outer ring 17 and the movable die 13 is narrow. However, there is a problem in that a density of the elastic material in the cavity 21 for molding the hub-side engagement section may not reach a predetermined value, and as a result, the strength of this section may be reduced, or imperfect molding due to lack of material may occur.

As an example of a power transmission device having the hub as described above, a power transmission device is known as shown in Japanese Unexamined Patent Publication No. 2006-258109.

### SUMMARY OF THE INVENTION

The present invention has been made to solve the above-mentioned problem and provides a hub for a power transmission device and a manufacturing method for such hub for the power transmission device, wherein a hub-side engagement section can be filled sufficiently by an elastic material, and therefore, the hub-side engagement section has sufficient strength, and imperfect molding due to lack of material does not occur.

In order to solve the above-mentioned problem, there is provided a hub for a power transmission device, having: an inner hub (59) made of a rigid body; a cylindrical section (61) made of an elastic body that is formed annularly around an outer circumference of the inner hub (59); a tubular outer ring (63) made of a rigid body that is fixed on an outer circumference of the cylindrical section (61) and protrudes from the outer circumference of the cylindrical section (61) in an axially rearward direction; and a hub-side engagement section (65) made of an elastic body that is formed on an axially rearward circumferential surface of the outer ring (63) and that is engaged with a pulley-side engagement section, wherein connection sections (81, 117, 125) made of elastic bodies that connect between a front end of the outer ring (63) and the hub-side engagement section (65) are formed at a front side of an outer circumference of the outer ring (63) where the hub-side engagement section (65) is not formed.

Further, in order to solve the above-mentioned problem, there is provided a manufacturing method for molding the above-mentioned hub for the power transmission device, comprising of the following steps: using a die for defining the hub for the power transmission device where outer ring (63) and inner hub (59) are loaded at predetermined positions inside thereof and an injection gate (93) is provided in the neighborhood of a front end of outer ring (63), wherein communication paths (95, 115, 135) that extend from injection gate (93) through a gap between the outer circumference of outer ring (63) and an inner circumference of die (83, 129) to a space for defining hub-side engagement section (65) are formed; and supplying an elastic body from the injection gate (93) to a space for defining the cylindrical section (61) on an inner side of the outer ring (63) and supplying the elastic body directly from the injection gate (93) through the communication paths (95, 115, 135) to the space for defining the hub-side engagement section (65).

Therefore, sufficient pressure and volume of the elastic material can be supplied through the communication paths (95, 115, 135) to a second cavity (91) for molding the hub-side engagement section (65), and the density of the elastic material for the hub-side engagement section (65) can be maintained at a predetermined value so as to afford sufficient strength and prevent imperfect molding due to lack of material.

Still further, in order to solve the above-mentioned problem, the connection sections (81) can be formed as convex ridges on the outer circumference of the outer ring. Further, the communication paths (95) can be formed as concave grooves on one inner circumferential surface of the die. Therefore, the communication paths in cooperation with the injection gate can be formed so as to reliably supply the sufficient pressure and volume of the elastic material to the hub-side concavo-convex section.

Still further, in order to solve the above-mentioned problem, the connection sections (117) can be formed along grooves formed on the outer circumferential surface of the outer ring. Further, the communication paths (115) can be formed as concave grooves on the outer circumferential surface of the outer ring. Therefore, the connection sections can be formed only by forming the concave grooves on the outer ring without changing the die, and therefore, cost can be reduced.

Still further, in order to solve the above-mentioned problem, there is provided a hub for a power transmission device, having: an inner hub (59) made of a rigid body; a cylindrical section (61) made of an elastic body that is formed annularly around an outer circumference of the inner hub (59); a tubular outer ring (263, 311, 321, 331, 341, 351, 361, 371) made of a rigid body that is fixed on an outer circumference of the cylindrical section (61); and a hub-side engagement section (65) made of an elastic body that is formed on an outer circumferential surface of the outer ring and that is engaged with a pulley-side engagement section, wherein communication openings (281, 313, 323, 333, 343, 353, 363, 373, 375) that extend from the cylindrical section (61) to the hub-side engagement section (65) are formed in the outer ring (263, 311, 321, 331, 341, 351, 361, 371), and communication sections (283) made of elastic bodies that extend from the cylindrical section (61) to the hub-side engagement section (65) are formed through the communication openings.

Still further, in order to solve the above-mentioned problem, there is provided a manufacturing method for molding the above-mentioned hub for the power transmission device, comprising the steps of: using a die (283, 285) for defining the hub for the power transmission device where the outer ring and the inner hub are loaded at predetermined positions and an injection gate (293) is provided in the neighborhood of a front end of the outer ring; and supplying an elastic body from the injection gate to a space for defining the cylindrical section on an inner side of the outer ring and supplying the elastic body through the communication openings in the outer ring to the hub-side engagement section.

Therefore, the sufficient pressure and volume of the elastic material can be supplied through the communication openings to the hub-side engagement section, and the density of the elastic material for the hub-side engagement section can be maintained at a predetermined value so as to afford sufficient strength and prevent imperfect molding due to lack of material.

In order to solve the above-mentioned problem, the communication openings (281, 313, 323, 333, 373) can be formed as holes. Therefore, the above-mentioned effect can be exhibited only by easily processing the outer ring, and cost can be prevented from increasing.

In order to solve the above-mentioned problem, the communication openings (343, 353, 363, 375) can be formed as slits. Therefore, the elastic material can be supplied uniformly in a circumferential or axial direction of the hub-side engagement section.

Reference numerals in parentheses affixed to the above means are examples showing correspondence with specific means set forth in embodiments described below.

The present invention may be more fully understood from the description of the preferred embodiments of the invention, as set forth below, together with the accompanying drawings.

### BRIEF DESCRIPTION OF THE DRAWINGS

In the drawings:

FIG. 1 is a longitudinal cross-sectional view showing a power transmission device having a hub that is a first embodiment of the present invention;

FIG. 2 is an axial front view showing the hub for the power transmission device shown in FIG. 1;

FIG. 3 is a side view showing the hub for the power transmission device shown in FIG. 1;

FIG. 4 is a cross-sectional view showing a molding method for the hub for the power transmission device shown in FIG. 1;

FIG. 5 is an axial front view showing a hub for a power transmission device that is a second embodiment of the present invention;

FIG. 6 is a side view showing the hub for the power transmission device shown in FIG. 5;

FIG. 7 is a side view showing an outer ring that is used in the hub for the power transmission device shown in FIG. 5;

FIG. 8 is a longitudinal cross-sectional view showing a power transmission device having a hub that is a third embodiment of the present invention;

FIG. 9 is a cross-sectional view showing a molding method for the hub for the power transmission device shown in FIG. 8;

FIG. 10 is a longitudinal cross-sectional view showing a power transmission device having a hub that is a fourth embodiment of the present invention;

FIG. 11 is an axial front view showing the hub for the power transmission device shown in FIG. 10;

FIG. 12 is a side view showing the hub for the power transmission device shown in FIG. 10;

FIG. 13 is a side view showing an outer ring that is used in the hub for the power transmission device shown in FIG. 10;

FIG. 14 is a cross-sectional view showing a molding method for the hub for the power transmission device shown in FIG. 10;

FIG. 15 is a side view showing another example of an outer ring that is used in the hub for the power transmission device that is the fourth embodiment of the present invention;

FIG. 16 is a side view showing yet another example of an outer ring that is used in the hub for the power transmission device that is the fourth embodiment of the present invention;

FIG. 17 is a side view showing yet another example of an outer ring that is used in the hub for the power transmission device that is the fourth embodiment of the present invention;

FIG. 18 is a side view showing an outer ring that is used in a hub for a power transmission device that is a fifth embodiment of the present invention;

FIG. 19 is a side view showing an outer ring that is used in a hub for a power transmission device that is a sixth embodiment of the present invention;

FIG. 20 is a side view showing another example of an outer ring that is used in the hub for the power transmission device that is the sixth embodiment of the present invention;

FIG. 21 is a side view showing an outer ring that is used in a hub for a power transmission device that is a seventh embodiment of the present invention; and

FIG. 22 is a diagram showing a molding method for a hub for a power transmission device in the related art.

### DESCRIPTION OF THE PREFERRED EMBODIMENTS

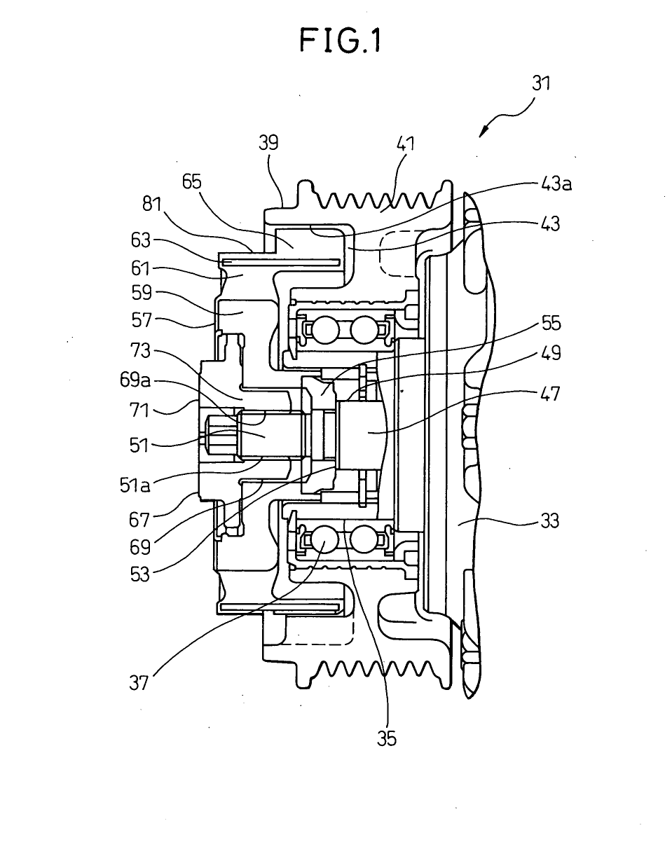

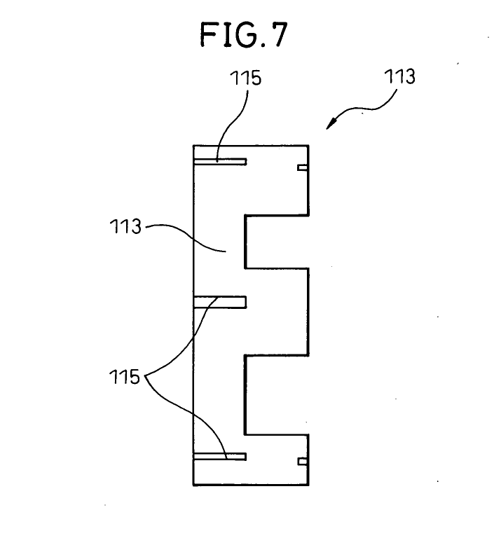

Hereinafter, the embodiments of the present invention will be described with reference to FIGS. 1-21.

FIGS. 1-4 show a power transmission device 31 to which a hub that is a first embodiment of the present invention is applied.

Power transmission device 31 has a housing 33 and a tubular bearing support section 35 is provided at a front side of the housing 33. A pulley 39 is supported on an outer circumference of the bearing support section 35 via a radial bearing 37. A belt groove 41 is formed on an outer circumference of the pulley 39 and a belt is wound around the belt groove 41 so that rotational torque is transmitted from a vehicle engine and the like. An annular pocket 43 is formed at a front side of the pulley 39, and a pulley-side concave-convex section 45 that has concaves and convexes in a radial direction is formed on an inner circumferential surface 43a of the annular pocket 43.

On the other hand, an input shaft 47 that transmits power to a compressor within the housing 33 is supported inside the tubular bearing support section 35. The input shaft 47 has a large diameter section 49 adjacent to the compressor and a small diameter section 51 at a front side thereof, wherein a stepped surface 53 is formed between the large diameter section 49 and the small diameter section 51, and a male thread section 51a is formed on an outer circumference of the small diameter section 51.

A washer 55 is fitted on the stepped surface 53 and around the small diameter section 51 and the hub 57 for the power transmission device is fitted on the washer 55.

The hub 57 for the power transmission device has a metallic inner hub 59 that extends frontward from the washer 55 and, then, expands radially outward. A cylindrical section 61 consisting of an elastic body such as rubber and the like is provided on an outer circumference of the inner hub 59. The cylindrical section 61 attenuates rotational fluctuations and acts as a damper for mitigating vibration, shock and the like. In order to stabilize quality of the cylindrical section, a metallic outer ring 63 is provided on an outer circumference of the cylindrical section 61. The outer ring 63 extends rearward from the outer circumference of the cylindrical section 61 into a pocket 43 of the pulley 39. A portion of the outer ring 63 that resides within the pocket 43 is provided with a hub-side concavo-convex section 65 that is formed on an outer circumferential surface of the outer ring 63. In the hub-side concavo-convex section 65, concaves and convexes that are radially depressed or projected are formed to be engaged with the pulley-side concavo-convex section 45 of the pulley 39 described above so that the rotational power of the pulley is transmitted to the hub 57.

On the other hand, a power interruption member 67 is provided inside the annular inner hub 59. The power interruption member 67 has: a cylindrical section 69 that has a female thread section 69a screwed with the male thread section 51a of the small diameter section 51; a nut section 71 that abuts against a front side surface of the inner hub 59; and a rupture section 73 that connects between the nut section 71 and the cylindrical section 69. Then, the female thread section 69a of the power interruption member 67 is screwed to the male thread section 51a of the small diameter section 51 so that the nut section 71 is pressed against the inner hub 59, and the inner hub 59 is pressed against the stepped surface 53 via the washer 55. As a result, the rotational torque that has been transmitted to the pulley 39 can be transmitted to the input shaft 47 to operate the compressor and the like.

In the power interruption member 67, when excessive torque is applied between the pulley 39 and the input shaft 47 due to seizure of the compressor and the like, a large force resulting from the screw engagement between the male thread section 51a of the small diameter section 51 and the female thread section 69a of the cylindrical section 69 is applied between the cylindrical section 69 and the nut section 71 to rupture the rupture section 73. At this time, the inner hub 59 cannot be pressed against the stepped surface 53 via the washer 55, and therefore, the torque transmission is interrupted.

In this power transmission device 31, the hub 57 for the power transmission device of this embodiment is provided with connection sections 81 consisting of an elastic material that are formed on the outer circumferential surface of the outer ring 63 and that extend from a front end of the outer ring 63 to the hub-side concavo-convex section 65.

The hub 57 for the power transmission device that has these connection sections 81 is manufactured by insert molding, wherein the metallic inner hub 59 and outer ring 63 are loaded in a die.

FIG. 4 is a cross-sectional view showing the insert molding by using the die. A stationary die 83 and a movable die 85 that are axially separated from each other form therebetween a cavity 87 for molding the hub 57 for the power transmission device and the inner hub 59 and the outer ring 63 are disposed as inserts in the cavity 87. A first cavity 89 for molding the cylindrical section 61 is formed between the inner hub 59 and the outer ring 63, and a second cavity 91 for molding the hub-side engagement section 65 is formed around the outer circumference of the outer ring 63. Further, an injection gate 93 is formed in the stationary die 83 in the neighborhood of the front end of the outer ring 63.

In this configuration, communication grooves 95 that extend from the injection gate 93 to the second cavity are formed on an inner circumferential surface of the stationary die 83 adjacent to the outer circumferential surface of the outer ring 63.

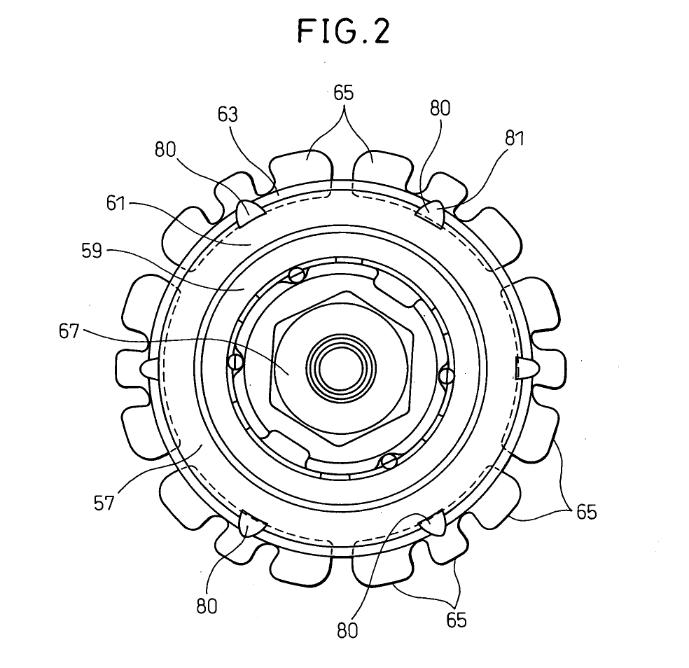

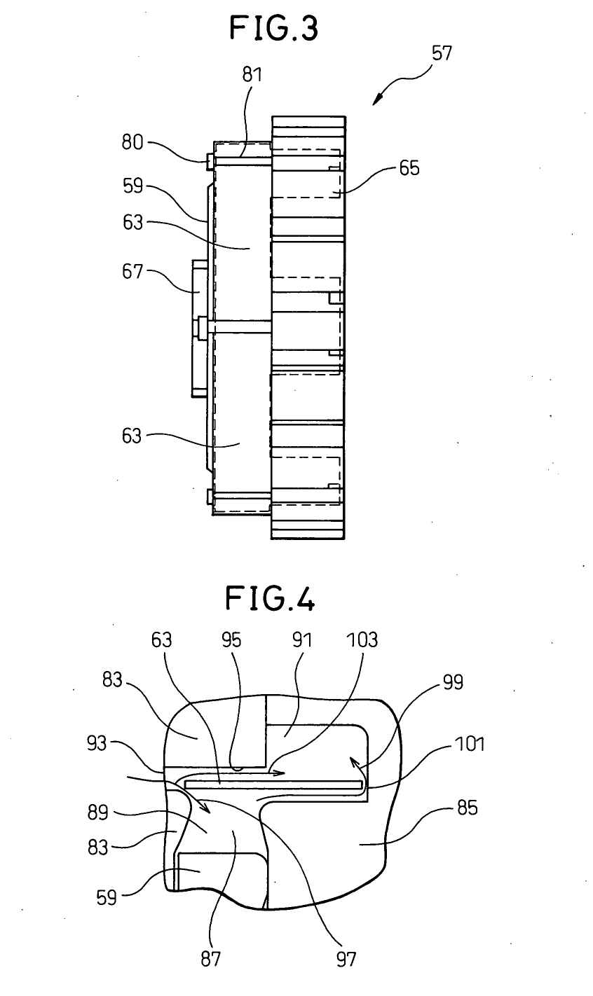

In order to mold the hub 57 for the power transmission device by using the die described above, a melted elastic material is injected into the cavity through the injection gate 93. As indicated by arrow 97, the elastic material supplied through the injection gate fills the first cavity 89 for molding the cylindrical section 61. Then, as indicated by arrow 99, the elastic material flows beneath the outer ring 63 and passes through a gap 101 between a rear end of the outer ring 63 and the movable die 85 to fill the second cavity 91 for molding the hub-side concavo-convex section 65. It is to be noted that the space beneath the outer ring 63 and the gap 101 in the rear of the outer ring 63 is narrow, and therefore, the second cavity 91 for molding the hub-side concavo-convex section 65 cannot always be filled sufficiently. However, in this molding method for the hub 57 for the power transmission device, the communication grooves 95 that extend from the injection gate 93 to the second cavity 91 are formed on an inner circumferential surface of the stationary die 83 adjacent to the outer circumferential surface of the outer ring 63. Therefore, as indicated by arrow 103, the sufficient volume and pressure of the elastic material can be supplied to the second cavity 91 through the communication grooves 95. The connection sections 81 formed on the outer circumferential surface of the outer ring 63 are the elastic material that remains and solidifies in the communication grooves 95. It is to be noted that a reference numeral 80 in FIGS. 2 and 3 designates a trace of the injection gate.

As described above, in this hub 57 for the power transmission device, the connection sections 81 consisting of the elastic material that extend from the front end of the outer ring 63 to the hub-side concavo-convex section 65 are formed on the outer circumferential surface of the outer ring 63, and in the manufacturing method for this hub 57 for the power transmission device, the communication grooves 95 that extend from the injection gate 93 to the second cavity 91 are formed on the inner circumferential surface of the stationary die 83 adjacent to the outer circumferential surface of the outer ring 63. Therefore, the sufficient pressure and volume of the elastic material can be supplied to the second cavity 91 for molding the hub-side concavo-convex section 65 through the communication grooves 95. Therefore, density of the elastic material for the hub-side concavo-convex section 65 can be maintained at a predetermined level so as to afford sufficient strength and prevent imperfect molding due to lack of material. Further, the communication grooves 95 in cooperation with the injection gate 93 can be formed so as to reliably supply the sufficient pressure and volume of the elastic material.

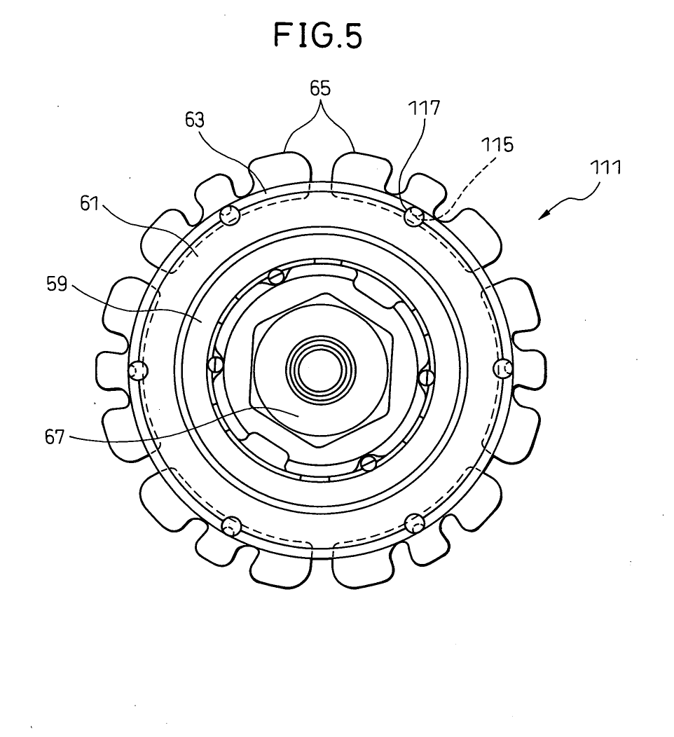

FIGS. 5-7 are diagrams showing a hub 111 for a power transmission device that is a second embodiment of the present invention.

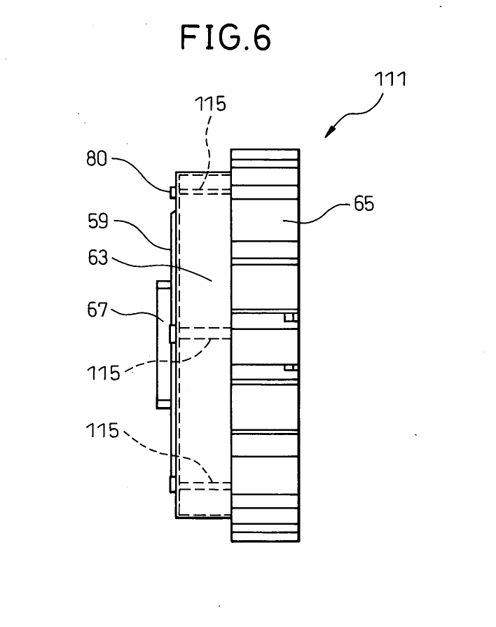

In the hub 111 for a power transmission device, as shown in FIG. 6, communication grooves 115 that extend from a position of the gate 93 to a position where the hub-side concavo-convex section 65 is formed are formed on an outer circumferential surface of an outer ring 113, and connection sections 117 consisting of an elastic material are formed in the communication grooves 115. Therefore, the sufficient pressure and volume of the elastic material can be supplied through the communication grooves 115 to the second cavity 91 for molding the hub-side concavo-convex section 65 so as to afford sufficient strength and prevent imperfect molding due to lack of material. Further, the communication sections can be formed only by forming concave grooves in the outer ring 113 without machining the die, and therefore, cost can be reduced.

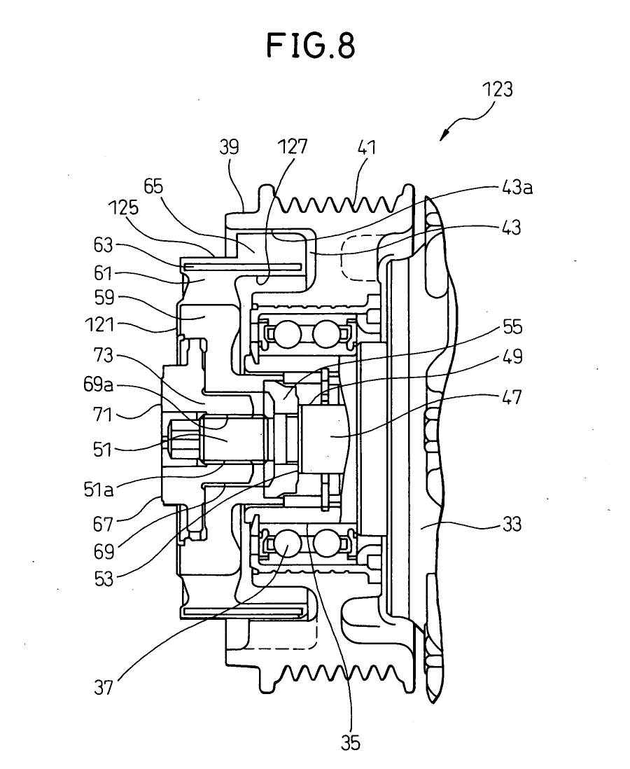

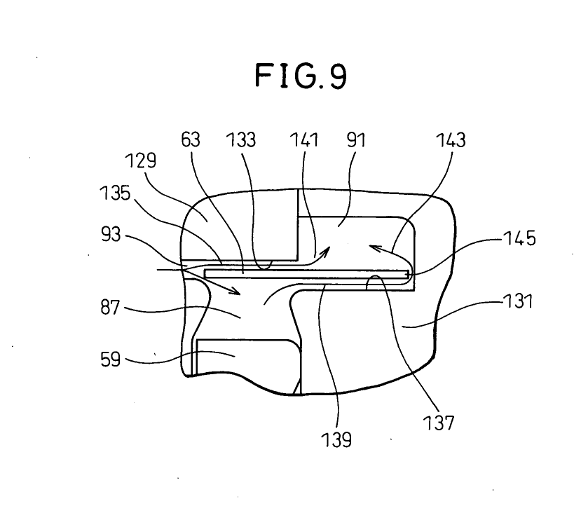

FIGS. 8 and 9 are diagrams showing a third embodiment of the present invention, wherein FIG. 8 is a diagram showing a power transmission device 123 having a hub 121, and FIG. 9 is a cross-sectional view showing a die for molding the hub 121 for the power transmission device.

In the hub 121 for the power transmission device, a thick cladding 125 consisting of an elastic material is formed on a portion of the outer circumferential surface of the outer ring 63 where the hub-side concavo-convex section 65 is not formed, and therefore, a thick cladding 127 consisting of an elastic material is formed on a portion of the inner circumferential surface of the outer ring 63 where the cylindrical section 61 is not formed.

The thick claddings 125 and 127 described above are molded by a stationary die 129 and a movable die 131 shown in FIG. 9. In this figure, an inner circumferential surface 133 of the stationary die 129 facing the outer circumferential surface of the outer ring 63 is apart from the outer ring 63 by a predetermined distance to form a gap 135 so that the thick cladding 125 is formed between the stationary die 129 and the outer ring 63. Further, an outer circumferential surface 137 of the movable die 131 facing the inner circumferential surface of the outer ring 63 is apart from the outer ring 63 by a predetermined distance to form a gap 139 so that the thick cladding 127 is formed between the movable die 131 and the outer ring 63. In this configuration, as indicated by arrow 141, the elastic material injected from the injection gate 93 passes through the large gap 135 between the outer ring 63 and the inner circumferential surface 133 and flows into the second cavity 91 for molding the hub-side concavo-convex section 65. On the other hand, as indicated by arrow 143, the elastic material supplied to the first cavity 87 passes through the large gap 139 between the outer ring 63 and the outer circumferential surface 137 and, then, a gap 145 between an end of the outer ring and the movable die 131 and flows into the second cavity 91. Therefore, the sufficient volume of the elastic material can be supplied to the second cavity 91 while maintaining sufficient pressure, so that sufficient strength can be afforded to the hub-side concavo-convex section 65 and imperfect molding due to lack of material can be prevented. Further, the thick claddings 125 and 127 can be formed only by changing the distances between the outer circumferential surface of the outer ring 63 and the stationary die 129 and between the inner circumferential surface of the outer ring 63 and the movable die 131, respectively, and therefore, cost can be reduced.

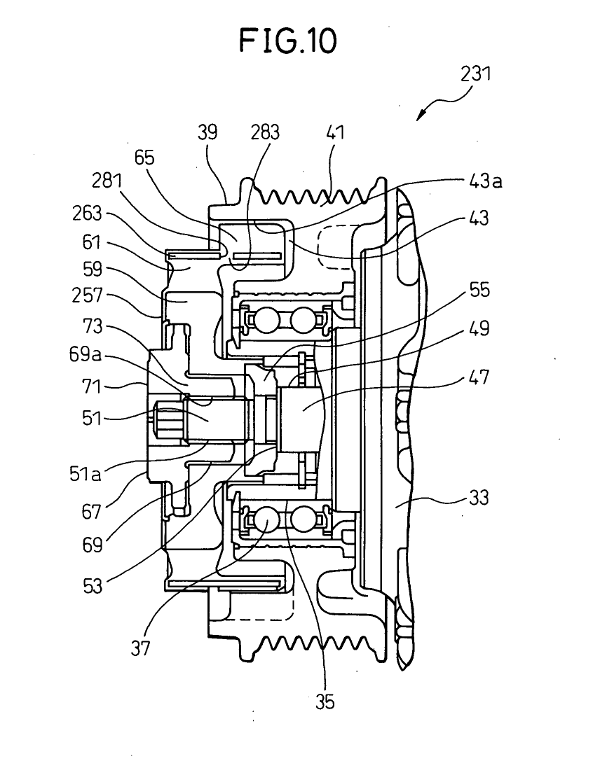

FIGS. 10-17 show a power transmission device 231 to which a hub 257 that is a fourth embodiment of the present invention is applied. In these figures, elements identical to those of the power transmission device 31 that is the first embodiment shown in FIG. 1 are designated by like reference numerals, a detailed description of which is omitted.

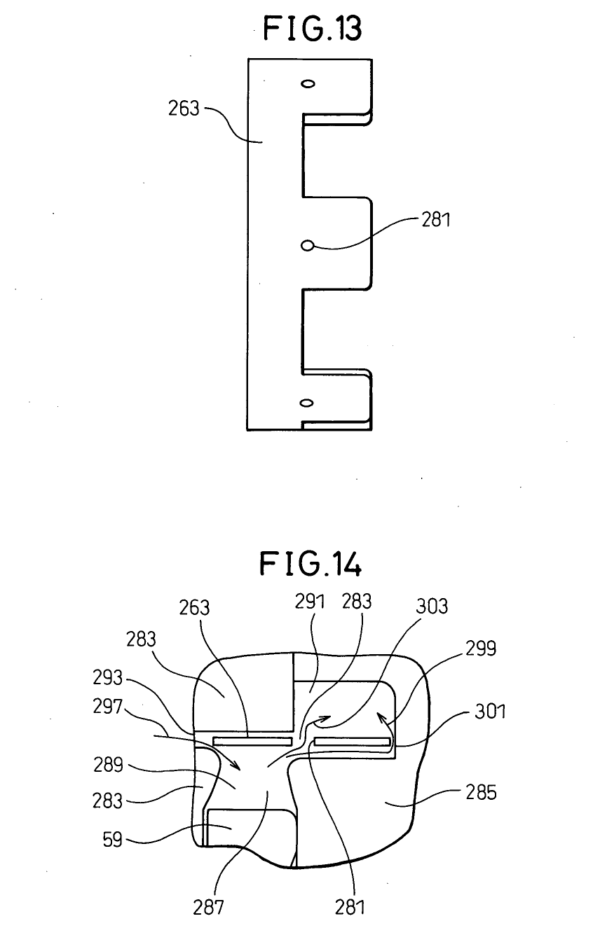

In the power transmission device 231, in the hub 257 for the power transmission device of this embodiment, circular communication holes 281 that extend from a cylindrical section 61 to a hub-side concavo-convex section 65 are formed in an outer ring 63 as shown in FIG. 13, and then, communication sections 283 consisting of an elastic material are formed in the communication holes 281.

The hub 257 for the power transmission device that has these communication sections 283 is manufactured by insert molding, wherein a metallic inner hub 59 and a metallic outer ring 263 are loaded in a die.

FIG. 14 is a cross-sectional view showing the insert molding by using the die. A stationary die 283 and a movable die 285 that are axially separated from each other form therebetween a cavity 287 for molding the hub 257 for the power transmission device and the inner hub 59 and the outer ring 263 are disposed as inserts in the cavity 287. A first cavity 289 for molding the cylindrical section 61 is formed between the inner hub 59 and the outer ring 263, and a second cavity 291 for molding the hub-side engagement section 65 is formed around the outer circumference of the outer ring 263. Further, an injection gate 293 is formed in the stationary die 283 in the neighborhood of a front end of the outer ring 263.

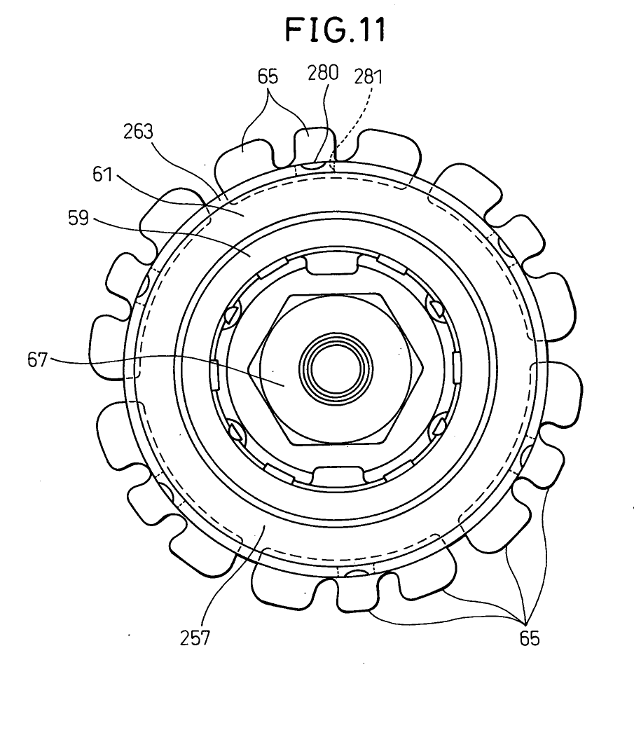

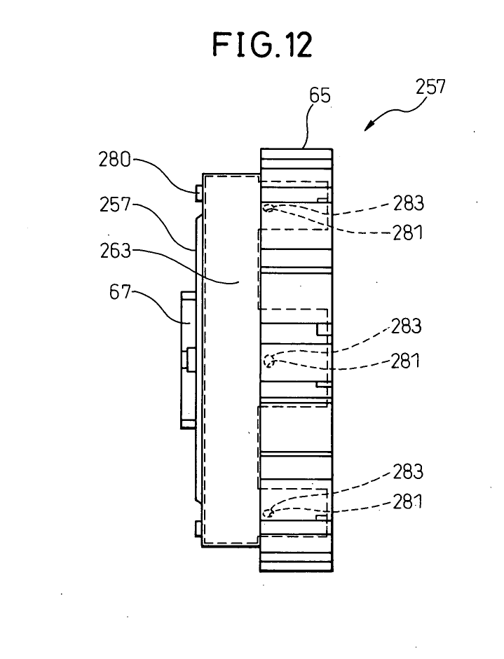

In order to mold the hub 257 for the power transmission device by using the die described above, an elastic material is injected into the cavity through the injection gate 293. As indicated by arrow 297, the elastic material supplied through the injection gate fills the first cavity 289 for molding the cylindrical section 61. Then, as indicated by arrow 299, the elastic material flows beneath the outer ring 263 and passes through a gap 301 between a rear end of the outer ring 263 and the movable die 285 to fill the second cavity 291 for molding the hub-side concavo-convex section 65. Here, it is to be noted that the gap 301 in the inner circumferential and rear side of the outer ring 263 is narrow, and therefore, the second cavity 291 for molding the hub-side concavo-convex section 65 cannot always be sufficiently filled. However, in this molding method for the hub 257 for the power transmission device, the communication hole 281 that extends from the first cavity 289 for molding the cylindrical section 61 to the second cavity 291 for molding the hub-side concavo-convex section 65 is formed in the outer ring 263. Therefore, as indicated by arrow 303, a sufficient volume and pressure of the elastic material can be supplied to the second cavity 291 through the communication holes 281 and the communication sections 283 consisting of the elastic material are formed in the communication holes 281. Here, it is to be noted that a reference numeral 280 in FIGS. 11 and 12 designates a trace of the injection gate.

As described above, in this hub 257 for the power transmission device, the communication sections 283 that extend from the cylindrical section 61 to the hub-side concavo-convex section 65 are formed in the outer ring 263. Further, in the manufacturing method for this hub 257 for the power transmission device, the communication holes 281 that extend from the first cavity 289 for molding the cylindrical section 61 to the second cavity 291 for molding the hub-side concavo-convex section 65 are formed in the outer ring 263. Therefore, the sufficient pressure and volume of the elastic material can be supplied to the second cavity 291 for molding the hub-side concavo-convex section 65 through the communication holes 281, and the density of the elastic material for the hub-side concavo-convex section 65 can be maintained at a predetermined level so as to afford sufficient strength and prevent imperfect molding due to lack of material.

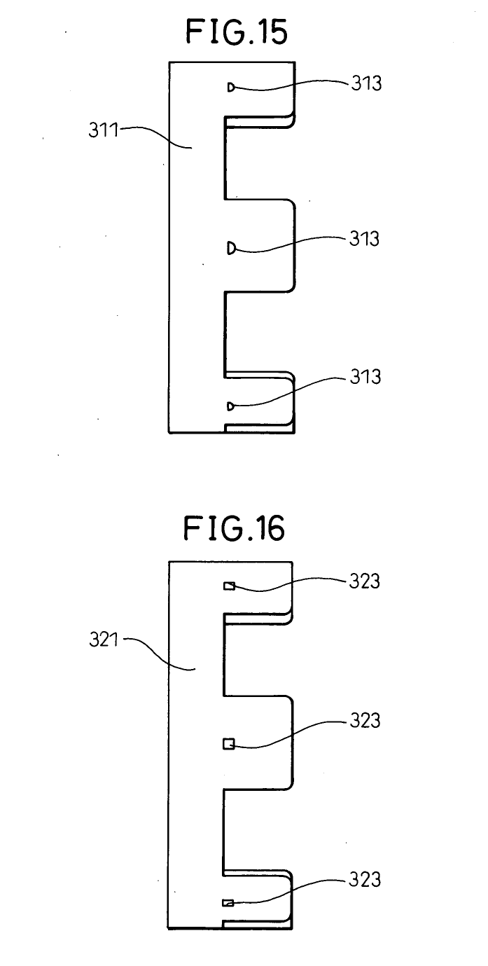

FIGS. 15-17 show other examples of the communication holes formed in the outer ring.

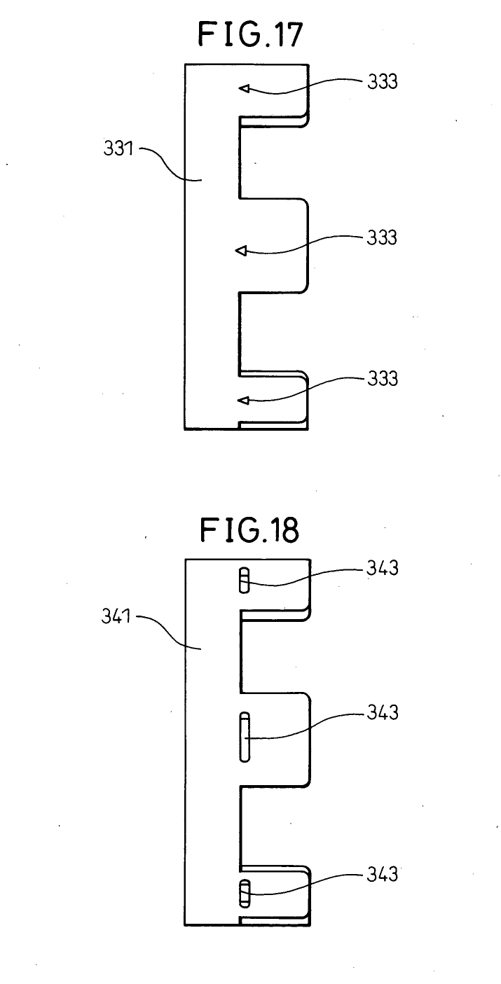

In the outer ring 311 shown in FIG. 15, semicircular communication holes 313 are formed. In the outer ring 321 shown in FIG. 16, rectangular communication holes 323 are formed. In the outer ring 331 shown in FIG. 17, triangular communication holes 333 are formed. The shape of the communication hole is not limited to the illustrated ones and communication holes of any shape such as an elliptic, polygonal and the like can be adopted.

FIG. 18 is a diagram showing a fifth embodiment of the present invention, wherein circumferentially elongated slits 343 are formed in an outer ring 341. In this configuration, an elastic material can be supplied more uniformly in the circumferential direction of the hub-side concavo-convex section 65, and therefore, uniformity of the supplied volume and pressure can be improved.

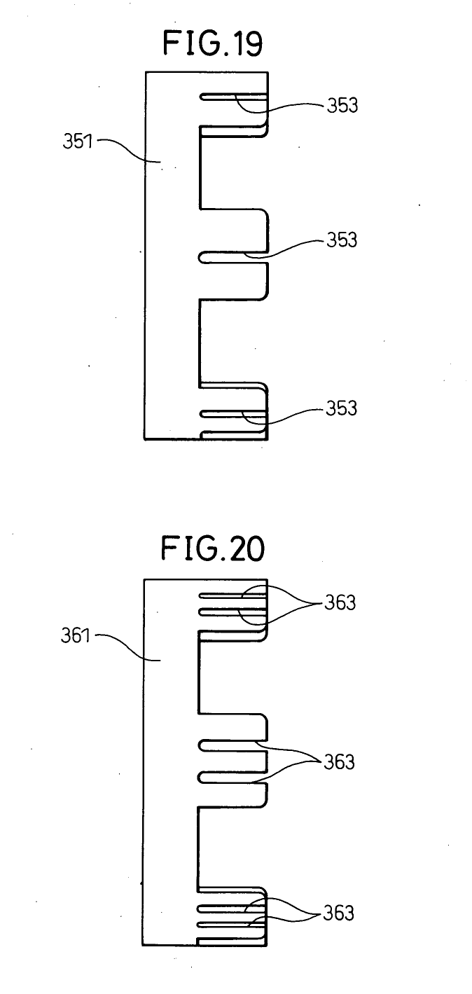

FIGS. 19 and 20 are diagrams showing a sixth embodiment of the present invention, wherein axially extending slits are formed in an outer ring. FIG. 19 shows that single-line slits 353 are formed in an outer ring 351, and FIG. 20 shows that double-line slits 363 are formed in an outer ring 361. In this configuration, an elastic material can be supplied more uniformly in the axial direction of the hub-side concavo-convex section 65, and therefore, uniformity of the supplied volume and pressure can be improved.

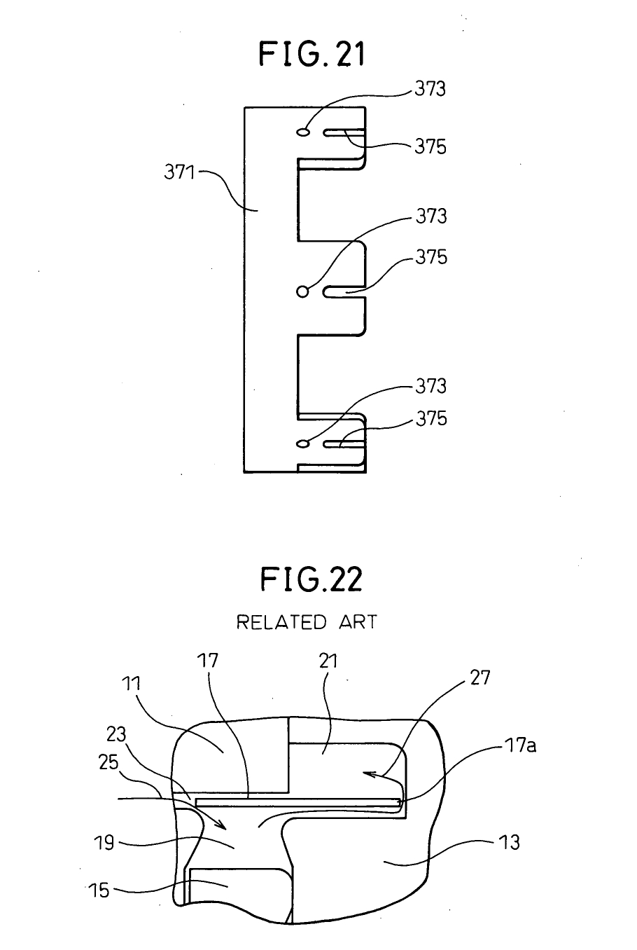

FIG. 21 is a diagram showing a seventh embodiment of the present invention, wherein circular communication holes 373 and axially extending slits 375 are formed in an outer ring 371. In this configuration, an elastic material can be supplied to the hub-side concavo-convex section 65 more uniformly.

While the invention has been described by reference to specific embodiments chosen for purposes of illustration, it should be apparent that numerous modifications could be made thereto by those skilled in the art without departing from the basic concept and scope of the invention.

1. A hub for a power transmission device, comprising:
an inner hub made of a rigid body;
a cylindrical section made of an elastic body that is formed annularly around an outer circumference of said inner hub;
a tubular outer ring made of a rigid body that is fixed on an outer circumference of the cylindrical section and protrudes from the outer circumference of said cylindrical section in an axially rearward direction; and
a hub-side engagement section made of an elastic body that is formed on an axially rearward circumferential surface of the outer ring and that is engaged with a pulley-side engagement section,
wherein connection sections made of an elastic bodies that connect between a front end of said outer ring and said hub-side engagement section are formed at a front side of an outer circumference of said outer ring where said hub-side engagement section is not formed.

2. A hub for a power transmission device according to claim 1, wherein said connection sections are formed as convex ridges on the outer circumference of said outer ring.

3. A hub for a power transmission device according to claim 1, wherein said connection sections are formed along grooves formed on the outer circumferential surface of said outer ring.

4. A manufacturing method for molding a hub for a power transmission device having:
an inner hub made of a rigid body;
a cylindrical section made of an elastic body that is formed annularly around an outer circumference of said inner hub;
a tubular outer ring made of a rigid body that is fixed on an outer circumference of the cylindrical section and protrudes from the outer circumference of said cylindrical section in an axially rearward direction; and
a hub-side engagement section made of an elastic body that is formed on an axially rearward circumferential surface of the outer ring and that is engaged with a pulley-side engagement section,
the method comprising the steps of:
using a die for defining the hub for the power transmission device where said outer ring and said inner hub are loaded at predetermined positions inside thereof and an injection gate is provided in the neighborhood of a front end of said outer ring, wherein communication paths that extend from said injection gate through a gap between the outer circumference of said outer ring and an inner circumference of said die to a space for defining said hub-side engagement section are formed; and
supplying an elastic body from said injection gate to a space for defining said cylindrical section on an inner side of said outer ring and supplying the elastic body from said injection gate through said communication paths to the space for defining said hub-side engagement section.

5. A manufacturing method for molding a hub for a power transmission device according to claim 4, wherein said communication paths are formed as concave grooves on an inner circumferential surface of said die.

6. A manufacturing method for molding a hub for a power transmission device according to claim 4, wherein said communication paths are formed as concave grooves on the outer circumferential surface of said outer ring.

7. A hub for a power transmission device, comprising:
an inner hub made of a rigid body;
a cylindrical section made of an elastic body that is formed annularly around an outer circumference of said inner hub;
a tubular outer ring made of a rigid body that is fixed on an outer circumference of the cylindrical section; and
a hub-side engagement section made of an elastic body that is formed on an outer circumferential surface of the outer ring and that is engaged with a pulley-side engagement section,
wherein communication openings that extend from said cylindrical section to said hub-side engagement section are formed in said outer ring, and communication sections made of elastic bodies that extend from said cylindrical section to said hub-side engagement section are formed through the communication openings.

8. A hub for a power transmission device according to claim 7, wherein said communication openings are formed as holes.

9. A hub for a power transmission device according to claim 7, wherein said communication openings are formed as slits.

10. A manufacturing method for molding a hub for a power transmission device having:
an inner hub made of a rigid body;
a cylindrical section made of an elastic body that is formed annularly around an outer circumference of said inner hub;
a tubular outer ring made of a rigid body that is fixed on an outer circumference of the cylindrical section; and
a hub-side engagement section made of an elastic body that is formed on an outer circumferential surface of the outer ring and that is engaged with a pulley-side engagement section,
wherein communication openings that extend from said cylindrical section to said hub-side engagement section are formed in said outer ring,
the method comprising the steps of:
using a die for defining the hub for the power transmission device where said outer ring and said inner hub are loaded at predetermined positions and an injection gate is provided in the neighborhood of a front end of said outer ring; and
supplying an elastic body from said injection gate to a space for defining said cylindrical section on an inner side of said outer ring and supplying the elastic body through said communication openings in said outer ring to said hub-side engagement section.

11. A manufacturing method for molding a hub for a power transmission device according to claim 10, wherein said communication openings are formed as holes.

12. A manufacturing method for molding a hub for a power transmission device according to claim 10, wherein said communication openings are formed as slits.
